(19) United States
(12) Patent Application Publication
(10) Pub. No.: US 2021/0294297 A1
(43) Pub. Date: Sep. 23, 2021

(54) METHOD FOR DETERMINING THE STATE OF WEAR OF A TOOL

(71) Applicants: Fraisa SA, Bellach (CH); GF Machining Solutions AG, Biel / Bienne (CH)

(72) Inventors: Josef MAUSHART, Solothurn (CH); Patrick KIEFER, Oftringen (CH); Fredi MAEDER, Solothurn (CH); Jean-Philippe BESUCHET, Neuchâtel (CH)

(21) Appl. No.: 17/202,488

(22) Filed: Mar. 16, 2021

(30) Foreign Application Priority Data
Mar. 17, 2020 (EP) 20163664.4

(51) Int. Cl. G05B 19/4065; B23Q 17/24

(52) U.S. Cl. CPC G05B 19/4065; B23Q 17/2457; B23Q 2717/006; G05B 2219/37256; B23Q 2717/003; G05B 2219/37559

(57) ABSTRACT

In a method for determining the state of wear of a tool, at least one optical image of a surface of the tool is recorded. Image data of the at least one optical image are processed in order to detect a wear zone. A surface extent and/or spatial extent of the wear zone is determined. The state of wear of the tool is classified on the basis of the extent determined. An apparatus for determining the state of wear of a tool correspondingly comprises a camera for recording at least one optical image of a surface of the tool, an image processing module which is configured in such a way that it processes image data of the at least one optical image in order to detect a wear zone, a computation module which is configured in such a way that it determines a surface extent and/or spatial extent of the wear zone, and a classifier module which is configured in such a way that it classifies the state of wear of the tool on the basis of the extent determined.

### CROSS-REFERENCE TO RELATED APPLICATIONS

This application claims the benefit and priority of European Patent Application No. 20163664.4 filed Mar. 17, 2020. The entire disclosure of the above application is incorporated herein by reference.

### FIELD

The invention relates to a method and an apparatus for determining the state of wear of a tool, as well as to a method for reconditioning a tool and to an arrangement having an apparatus for determining the state of wear and a device for reconditioning a tool.

### BACKGROUND

Many tools, in particular ones for material processing by machining, such as milling cutters, drills, etc., are subject to wear because of their interaction with the workpieces. To a certain extent, this entails a degraded processing outcome, longer processing times and/or irreparable damage to the tool (or even to the workpiece). Particularly in the case of tools which are used in automatically operating machines, the tools are therefore removed from the machine in good time before effects as mentioned above occur. When possible, the tools are then reconditioned for further use, for example by processing elements thereof being replaced or reconditioned (for example reground). If reconditioning is not (no longer) possible, in general or because of the state of wear, the tools are sent for recycling or disposed of.

The removal and replacement of tools may respectively be carried out after a predetermined length of time or a predetermined number of processing cycles, the time or the number being selected in such a way that, for the corresponding tool type, no negative effects are yet to be expected even in a worst case scenario. The tools are therefore in general removed and replaced, and reconditioned, somewhat too early. Correspondingly, the effective service life of the tools is shortened, and the number of tool replacements and tool reconditionings is greater than actually necessary.

As an alternative, the tools and/or the processing outcome on the workpiece are evaluated by the operator, depending on the tool with the naked eye or with the assistance of aids, for example magnifying glasses, microscopes or measuring instruments. The operator then decides whether continued use is possible.

The evaluation is work-intensive and generally requires a shutdown of the corresponding machine, and often also removal of the tool therefrom. Particularly when the evaluation is carried out by different individuals, there are also inconsistencies in the assessment.

Systems for automatic wear detection have already been proposed. For instance, CN 108107838 A (Shandong University) relates to wear detection on cutting tools. To this end, a cloud-based knowledge database of wearing data is established and a detection model is trained on the basis of a support vector machine (SVM). The data are updated continuously so that the detection is improved.

U.S. Pat. No. 7,479,056 B2 (Kycera Tycom) describes a fully automatic system for checking the identity and geometry of a drilling tool, for reconditioning the tool, for checking with the aid of predetermined tolerances, for adjusting a positioning ring on the tool shaft, and for cleaning and packaging the reconditioned tool. The checking of the geometry is carried out with optical units. These respectively comprise head-side and front-side cameras for imaging the end and lateral surfaces of the tool. Data generated during the tool checking may be stored in the controller. With the aid of the recorded images, predetermined reference points are identified and distances between them are measured. Furthermore, an initial estimate of the cutting edge state is carried out.

U.S. Pat. No. 7,479,056 B2 discloses no further details relating to the evaluation of the image data. The initial estimate is made with the aid of the external geometry of the tool and the state of the cutting edges, although the way in which this can be determined or classified is not clear.

### SUMMARY OF THE INVENTION

It is an aspect of the invention to provide a method associated with the technical field mentioned in the introduction, which can automatically and reliably detect the state of wear of a tool.

According to the preferred embodiment of the invention, the method comprises the following steps:
a) recording at least one optical image of a surface of the tool;
b) processing image data of the at least one optical image in order to detect a wear zone;
c) determining a surface extent and/or spatial extent of the wear zone; and
d) classifying the state of wear of the tool on the basis of the extent determined.

Depending on the tool and application, the wear may be manifested in various ways. In comparison with an unused tool fit for operation, for example, certain dimensions are reduced because of material ablation on the tool, deformations which lead to a modified geometry occur, or individual regions comprise wearing traces on the surface and/or as far as a certain depth. A “wear zone” in this case refers to that area of the tool surface which comprises significant wear traces. The type of traces which these are is to be established as a function of the tool. For example, typical circumferential grooves of shallow depth in the case of rotary tools are generally not to be assigned to a wear zone, while splintering generally indicates wear relevant to the processing outcome and/or the tool performance, and corresponding areas are therefore to be assigned to a wear zone.

The optical image is a recording in the visible range of the spectrum or in neighbouring wavelength ranges (IR and UV). In general, the tool, or its area of interest, is illuminated and light reflected at the surface is acquired with a suitable device (camera; imaging optics with image sensor). The light for the illumination may have a continuous spectrum or a spectrum composed of a plurality of wave lines or frequency bands, or it may be monochromatic. The camera may also acquire a broad frequency band, one or more narrow bands or a particular frequency; it may likewise impart monochromatic or polychromatic information.

The acquired surface may comprise the entire tool. In general, a plurality of optical images which at least partially image different areas of the tool surface are recorded, the entire tool surface not being imaged even when considering the plurality of optical images together, but rather only areas of interest, for example cutting edges and adjacent regions. If uniform wearing can be assumed, it may be sufficient only to acquire representative areas. If point wearing (for example splintering) is to be expected, it is generally expedient to optically acquire all potentially affected regions so that the cutting areas are fully acquired, for example when considering one or more optical images together.

The processing of the image data is carried out with computer assistance. According to the invention, a wear zone is detected. This is a surface area in which significant material ablation has taken place and which is differentiated optically from its surrounding surface.

The surface extent and/or spatial extent of the wear zone is a quantitative indication. It may be determined absolutely (for example as a specification in μm₂ or μm³) or relatively in relation to a defined reference surface, or a defined reference volume (for example the surface of a working area of the tool or the volume of the tool, or of a cutting element, or the like). In the case of a fixed imaging ratio, areas or volumes need not be converted into physical units, a specification of the number of pixels or number of voxels then being sufficient.

The classification assigns the state of wear of the tool to one or more classes. In the simplest case, there are only two classes for selection, namely “still usable” and “not still usable”. Classification with at least three classes: “still usable”, “recondition”, “dispose of” is advantageous. More than three classes are possible, for example in relation to the following information:
i) assignment to one of several possible reconditioning methods (polishing, grinding, recoating, etc.)
ii) for tools which are still usable: specification of the state (“as new”, “slightly worn”, “very worn”) in relation to the time of the next check or directly the assignment of a checking interval;
iii) advice that the tool is still partially usable in particular methods but not in others, in which for example a hard material or one which is difficult to process needs to be processed or a particularly high precision is sought.

It is likewise possible to carry out separate classifications for the state of wear of different areas of the tool (for example the tool end and the lateral tool surface), so that for example reconditioning is necessary only in certain areas of the tool.

Besides the extent determined, other features may also be used for the classification, and specifically those which have been determined on the basis of the optical image and those from external sources. The latter may for example be based on different types of measurements, for example electrical or magnetic measurements, or related to the use of the tool hitherto carried out (number of cycles, materials processed). Lastly, parameters which have been obtained from an examination of workpieces processed with the tool may also be included.

The method according to the invention may be used in connection with a large number of tools, in particular with those which act mechanically on the workpiece or which are ablated because of the interaction with the workpiece. The first group includes tools for material processing by machining, specifically both rotary tools for milling, drilling or thread cutting, and stationary or linearly moved tools such as lathes, stamping tools or saws. The second group includes in particular electrodes, such as are used for example in the context of EDM methods (spark eroding).

The method is configured, in particular, to determine the state of wear of one of the following tools:
an electrode for eroding in a sinker EDM machine,
a wire for eroding in a wire EDM machine,
a grinding or drilling tool for workpiece processing in a machine tool.

The wear determination may be carried out fully automatically, and compared with manual assessment it furthermore provides an objective picture since all tools are assessed in the same way. By virtue of the automation, the wear determination may be carried out at regular intervals, so that on the one hand deficiencies in the processing outcome due to excessively worn tools can be avoided, and on the other hand tools which are actually still usable are not reconditioned, disposed of or recycled prematurely.

Preferably, the image data comprise a two-dimensional image of the surface, and the image data corresponding to the two-dimensional image are used to detect the wear zone. Two-dimensional images can be processed efficiently, and it is already possible to determine the extent of a wear zone precisely with the aid of one or more two-dimensional images. The wear zone is manifested for example in a modified surface structure, which also optically differs clearly from an area not affected by wear. The distinguishability may optionally be improved by illuminating the tool with light of a particular spectral composition, a particular beam shape and beam direction, and/or a particular intensity.

Advantageously, the image data comprise a three-dimensional image of the surface and the image data corresponding to the three-dimensional image are used to detect the wear zone and/or to determine the extent of the wear zone.

It is possible to detect the wear zone directly with the aid of the three-dimensional image (or a plurality of three-dimensional images) (so that a two-dimensional image is not needed), or the wear zone is detected with the aid of a two-dimensional image and the three dimensional image is only used for determining the extent—in particular the spatial extent—of the wear zone. In parallel with a spatial extent, it is also possible to determine the surface extent with the aid of the two-dimensional and/or three-dimensional image.

In principle, the following variants inter alia are thus possible:

| Step | Var. A | Var. B | Var. C | Var. D | Var. E |
|---|---|---|---|---|---|
| Detection of wear | 2D | 2D | 2D | 2D | 3D |
| zone | | | | | |
| Determination of | 2D | 2D | 2D | 3D | 3D |
| surface extent | | | | | |
| Determination of | — | 2D | 3D | 3D | 3D |
| spatial extent | | | | | |

If the spatial extent is intended to be determined according to Variant B with the aid of two-dimensional images, for example a plurality of two-dimensional images are used or a comparison with saved geometrical data is carried out. A three-dimensional image may initially be obtained from a multiplicity of two-dimensional images, or the spatial extent of the wear zone is deduced directly from the two-dimensional images.

Combinations are furthermore possible, so that both two-dimensional and three-dimensional images are used for the detection of the wear zone, and for the determination of the surface extent or the spatial extent.

In one preferred embodiment, the at least one optical image is obtained using a white-light interferometer (WLI). Such instruments comprise a broadband light source, the light of which is directed on the one hand by means of a beam splitter onto the object to be examined and reflected or scattered by it back to a camera (measurement branch), and on the other hand by means of one or more mirrors likewise to the camera (reference branch), where the two beams are superimposed. (Axial) profiling of the object to be examined leads to different path length differences between the measurement and reference branches, and therefore to a varying interference signal.

Such instruments allow precise three-dimensional profile measurements, for example of surfaces, an axial resolution of for example about 100 nm and a lateral resolution in the micrometre range being achieved.

The two-dimensional image may be obtained from a signal amplitude of the white-light interferometric optical image. This gives sharp images with a sufficiently high resolution. Both two-dimensional and three-dimensional images may therefore be obtained from the same optical image, or the same optical images.

The three-dimensional image is correspondingly likewise obtained from the white-light interferometric optical image, or more precisely from the interference signal.

In general, it is advantageous for both the three-dimensional information and the two-dimensional image to be obtainable from information of the same acquisition process. On the one hand, the number of acquisition processes and therefore the acquisition time are minimized, and on the other hand the information may already be mutually aligned with pixel accuracy from the start.

The invention is not, however, restricted to the evaluation of white-light interferometric recordings. Optical images from other sources may also be used.

For example, a microscope camera may be used to generate two-dimensional image data. If three-dimensional image data are needed, these may for example be generated by means of a 3D camera, for example a ToF camera, or with confocal sensors, or from a plurality of two-dimensional images, the two-dimensional images having for example been recorded from different angles. The tool surface area to be examined may likewise be illuminated with a suitable pattern, for example a stripe pattern, in order to obtain information relating to the three-dimensional profiling. The shadowing which results from different illumination directions may also be evaluated in order to generate three-dimensional information.

Advantageously, a spatial deviation of a current profile of the surface from a setpoint profile of a cutting edge is determined in order to determine the extent of the wear zone. In this way, the (spatial) extent may be determined precisely. It corresponds to the difference between the setpoint volume of the unworn tool and the current volume of the tool (in a predetermined area). This wear volume is in many cases a good measure of the state of wear of the tool.

As an alternative, for example, a setpoint value or a minimum value for the tool volume in a particular area may be specified, and the total volume determined is compared therewith.

In one preferred embodiment, the setpoint profile of the cutting edge of the tool is reconstructed on the basis of the image data. Assuming that in real cases the wear does not exceed a certain extent, for conventional tools the unworn cutting edge may be reconstructed from (in particular spatial) geometrical data which represent the current state of the tool, for example by an interpolation with a suitably parameterized curve.

As an alternative, the setpoint profile may be obtained from pre-existing data, for example general geometrical data for a particular tool type or specific data for the tool in question (digital twin).

Advantageously, a wear volume is calculated with the aid of the deviation determined. It corresponds to the spatial extent of the wear zone and reflects the volume loss which has occurred because of the wear, compared with the original unworn tool.

As an alternative or in addition, surface or linear deviations may be quantified, for example in a cross section which comprises the (setpoint) cutting edge, or as a maximum or average distance between the setpoint cutting edge and the remaining surface.

For the wear assessment of a tool, it is possible to determine a plurality of measures of the wear and evaluate them for the classification. In the case of a solid-shaft tool, for example, in the region of the cutting edge the wear volume may be determined on the basis of a reconstruction of the cutting edge, while in other areas, for example at a cutting tip where a reconstruction of a cutting edge is difficult or impossible, a surface measure is used, for example the surface extent of the wear zone. The wear may thus be assessed reliably in areas of different geometry.

In one preferred embodiment, a machine learning algorithm is used for detecting the wear zone. This algorithm may, for example, be trained by a human assessor with the aid of real or simulated image data of worn tools. Ultimately, the algorithm should distinguish those areas in the image data which are to be attributed to the wear zone, for example by the corresponding pixels being correspondingly marked in a pixel map.

Because the machine learning algorithm is based on training data in which, inter alia, the wear zone is already distinguished in the required way (for example manually), such an algorithm may be trained purely on the basis of the selection of different training data for a wide variety of tool types. With increasing use, furthermore, the precision of the result may be increased further by entering additional information as training data, for example subsequent corrections to the result of the machine learning algorithm. These may also be obtained from downstream processes, for example the reconditioning of the tool.

Preferably, the machine learning algorithm comprises an artificial neural network. Such a network, which has proven suitable for the present purpose, is for example VGG-16 (K. Simonyan, A. Zisserman: “Very Deep Convolutional Networks for Large-Scale Image Recognition”, arXiv: 1409.1556 (2014)).

Instead of a machine learning algorithm, other algorithms may also be used to detect the wear zone, for example pattern matching algorithms.

In one preferred application, the state of wear of a solid-shaft tool is determined, a first state of wear of a cutting geometry on the lateral side and a second state of wear of a cutting geometry on the end side being determined separately.

The different geometrical conditions and the different requirements for the intactness of the corresponding cutting edges may therefore be taken into account. In the case of milling tools, for example, the cutting edges are often stressed less strongly on the end side than in the case of drilling tools, while the situation is precisely the opposite for the cutting on the lateral side.

For the classification of an “overall state of wear”, the first state of wear and the second state of wear may be obtained differently and/or used differently. In the simplest case, a tool is to be replaced when at least one of the two states of wear requires replacement, and the tool is to be reconditioned when at least one of the two states of wear necessitates reconditioning. If the overall performance of the tool does not simply correspond to the weakest link but is given by an interaction of the performances of the two tool sections, it may be expedient to correlate the states of wear with one another in a more complex way so that reconditioning or replacement does not take place until the overall performance so requires.

Advantageously, an algorithm based on a first data set is used to determine the first state of wear, in particular for the detection of the wear zone, and an algorithm based on a second data set is used to determine the second state of wear, in particular for the detection of the wear zone, the first data set and the second data set being different. In particular, the two data sets are substantially disjoint. For example, the first data set comprises image data which show the lateral area of worn tools as training data for a machine learning algorithm, and the second data set comprises image data which show the end area of worn tools. There is in this case an overlap of the first and second data sets at most in a transition region (edge or radius) between the lateral surface and the end.

Not only the datasets but also the algorithms used may be different, and for example different machine learning algorithms or algorithms with other parameters (for example network topologies in the case of neural networks) may be used.

A method according to the invention for reconditioning a tool comprises the following steps:
a) determining the state of wear of a tool with a method according to one of claims 1 to 9;
b) controlling at least one device for reconditioning the tool, in particular by means of a grinding process, when the state of wear satisfies predetermined conditions.

The predetermined conditions (also) comprise in particular the classification of the state of wear of the tool. Thus, the classes may be defined from the start in such a way that they correspond to measures to be carried out (“still usable”, “recondition”, “dispose of”), or the measures are derived directly or indirectly from a classification. For example, the state of wear is classified into eight classes 1-8 (1: as new, 8: very worn), the conditions being specified in such a way that the tool continues to be used with a classification in classes 1 and 2, reconditioning is carried out with a classification in classes 3-6, and the tool is recycled or disposed of with a classification in classes 7 and 8.

The state of wear may be used not only as a basis for the decision whether reconditioning should be carried out with the corresponding device, but may also be relevant for the measures to be carried out in the context of the reconditioning. For example, a plurality of reconditioning steps are available for selection (polishing, grinding, a plurality of grinding processes, etc.), and a different selection is made depending on the state of wear.

Advantageously, a processing geometry of the device for reconditioning the tool is determined with the aid of the at least one recorded optical image. This defines the scope, the location and the nature of the processing of the tool. Besides the aforementioned selection of the processing steps, a grinding path may for example also be determined as a function of the current geometry of the tool. The determination of the processing geometry may be based directly on the optical image and/or on processing outcomes, for example from the determination of the extent of the wear zone or the classification.

Tool-specific, need-based reconditioning is thereby made possible. In the case of grinding methods, for example, the (additional) material ablation may be minimized so that the service life of the tool is maximized. It is furthermore not necessary to carry out elaborate examination of the tool (again) in advance of the reconditioning, because the required data are already available.

In one preferred embodiment of the reconditioning method according to the invention, a device for recording the at least one optical image is arranged at a first use location and data obtained at the first use location are saved in a database. The reconditioning device is arranged at a second use location and the reconditioning device retrieves data from the database. In this case, the two use locations are at a distance from one another and are located, in particular, in another device or another factory. The database may be centrally arranged, so that the data are acquired and used decentrally but stored centrally. The database may, however, also be saved at the first use location or at the second use location, or the data are held at both locations and synchronized regularly.

In particular, this also makes it possible to fully acquire and hold data relevant for a particular tool even when the tool (respectively after reconditioning has been carried out) is used by different users or even reconditioned by different service providers.

Preferably, the tool is provided with a unique identifier, and the data assigned to the tool in the database are linked with the unique identifier. The unique identifier is in particular applied on the tool in machine-readable form, for example as an optical marking (barcode, matrix code, alphanumeric, etc.) or stored on a data carrier (for example RFID). The unique identifier ensures that correct assignment takes place.

As an alternative, the acquired data are stored on a data carrier. This is then transported together with the corresponding tool from the first use location to the second use location.

In a further case, the recording of the at least one optical image takes place directly at the reconditioning device.

An apparatus according to the preferred embodiment of the invention for determining the state of wear of a tool comprises:
a) a camera for recording at least one optical image of a surface of the tool;
b) an image processing module, which is configured in such a way that it processes image data of the at least one optical image in order to detect a wear zone;
c) a computation module, which is configured in such a way that it determines a surface extent and/or spatial extent of the wear zone; and
d) a classifier module, which is configured in such a way that it classifies the state of wear of the tool on the basis of the extent determined.

Preferably, the camera is integrated into a processing machine having a holder for the tool, particularly in such a way that the camera can record the optical image of the surface of the tool when the tool is held in the holder.

The processing machine may be a machine tool for drilling or milling, a processing centre or an EDM machine. The holder may for example be a working spindle, a holder in a magazine for holding the tools for tool changing, or a transport holder for transfer of the tool between a working spindle and a magazine, and vice versa.

A processing machine which comprises a camera and which is connected to a processing apparatus, or fully or partially contains the latter, is thus in particular also advantageous, the processing apparatus comprising the image processing module, the computation module and the classifier module.

A machine tool arrangement according to the preferred embodiment of the invention comprises a machine tool, preferably a processing centre, a sinker or wire EDM machine or a drilling centre, and an apparatus according to the invention for determining the state of wear. In this case, the camera is integrated into the machine tool or is arranged thereon. The image processing module, the computation module and the classifier module are held in a processing apparatus. In this case, the processing apparatus is fully or partially contained in the machine tool or is arranged externally to the latter and connected to it in respect of signals.

An arrangement according to the preferred embodiment of the invention comprises:
a) an apparatus according to the invention for determining the state of wear of a tool;
b) a device for reconditioning the tool, in particular by means of a grinding process;
c) a controller for controlling the reconditioning device, which is configured in such a way that it receives information relating to the state of wear from the determination device and controls the device for reconditioning the tool as a function of the information received.

Thus, the processing machine is preferably assigned a camera by means of which the state of wear of the tools used in the machine can be regularly monitored, for example at each tool change. The image data are processed further according to the invention directly at the location of the processing machine, so that with the aid of the classification it is possible to decide whether the tool is still usable. If this is the case, it is placed in the tool magazine. Otherwise, it is withdrawn and data relating to the state of wear (and optionally the image data or further information obtained therefrom) are stored in a database. The withdrawn tool is then physically transported to the reconditioning device. The latter reads the data assigned to the tool from the database and controls the reconditioning device as a function thereof. The reconditioned tool is then transported to the same processing machine or another processing machine, and is reused there.

Further data, for example relating to the history of the tool (number of use cycles, previous reconditionings, etc.) or relating to the customer requirements for its specific processing operations, may be used for the reconditioning.

Further advantageous embodiments and feature combinations of the invention may be found from the following detailed description and the set of patent claims.

### BRIEF DESCRIPTION OF THE DRAWINGS

In the drawings used to explain the exemplary embodiment:

FIG. 1 shows a schematic block diagram of an installation according to the invention for determining the state of wear of and for reconditioning a tool;

FIG. 2 shows a side view of a milling tool with a schematic representation of image areas;

FIG. 3 shows a first two-dimensional image of an area of a worn tool, obtained from the signal amplitude of a white-light interferometric recording;

FIG. 4 shows a second two-dimensional image of an area of a worn tool, obtained from the signal amplitude of a white-light interferometric recording;

FIG. 5 shows a three-dimensional representation of the area according to the second image;

FIG. 6 shows a reconstructed three-dimensional view of a cutting-edge and cutting-tip area of a milling tool;

FIG. 7 shows sections through the three-dimensional view according to FIG. 6 with a reconstructed cutting edge; and

FIG. 8 shows a bar chart with the wear surfaces in successive cross sections through the tool.

In principle, parts which are the same are provided with the same references in the figures.

### DETAILED DESCRIPTION

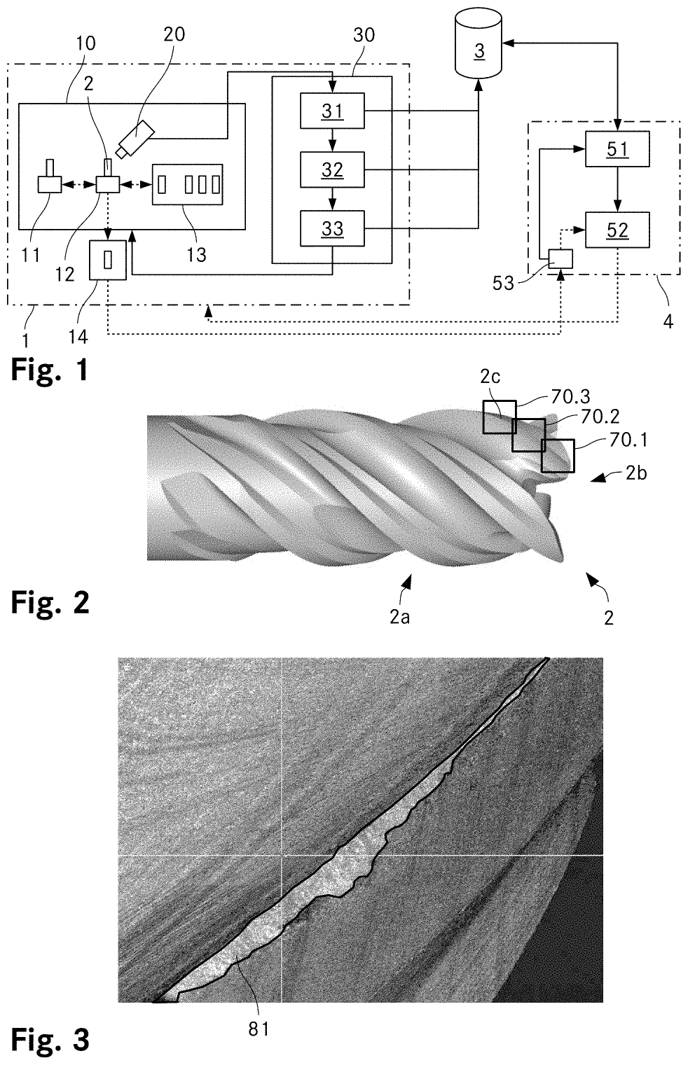

FIG. 1 is a schematic block diagram of an installation according to the invention for determining the state of wear of and for reconditioning a tool.

The installation comprises a processing machine 10, for example a milling machine, which is arranged in a first factory 1. In the manner known per se, the processing machine comprises (at least) a working spindle 11, a tool magazine 13 and a transfer device with a tool holder 12, by means of which tools 2 can be exchanged between the working spindle 11 and the tool magazine 13. In the example described, the tools are solid-shaft milling cutters with helical main blades on the lateral surface 2a and straight secondary blades on the end side 2b of the tool 2 (see FIG. 2). The transfer device also makes it possible to withdraw a tool 2, the tool 2 being moved into a removal position 14.

The processing machine 10 is assigned a white-light interferometer 20, by means of which images of the cutting region of a tool 2 held in the tool holder 12 of the transfer device can be recorded. The white-light interferometer 20 and the tool holder 12 may in this case be positioned in different relative placements, so that a plurality of images of different areas of the cutting region can be recorded.

The white-light interferometer 20 is an instrument of the helilnspect H6 type from the company Heliotis AG, Root (Lucerne), Switzerland. It comprises an LED light source, a Michelson objective and a CMOS image sensor. The white-light interferometer itself is arranged on a 4-axis system (X, Y, Z, R(Y)) so that it can be positioned flexibly relative to the tool 2 held in the tool holder 12.

The white-light interferometer 20 offers a measurement field of 0.56×0.54 mm, a depth range of 2 mm being acquirable. The axial accuracy is 100 nm, and the lateral accuracy is 2 μm. The instrument provides a three-dimensional point cloud and a two-dimensional image, which corresponds to the measured signal amplitude. The latter is comparable to a greyscale image of the acquired area.

A plurality of image areas 70.1, 70.2, 70.3, which correspond to a relevant area of the tool surface and, for example, are arranged along a cutting edge 2c starting from the cutting tip, are now acquired in succession by the white-light interferometer 20—as schematically represented in FIG. 2. To this end, the camera of the white-light interferometer 20 is moved relative to the tool 2 with the aid of the 4-axis system. In principle, areas on the lateral surface 2a of the tool 2 as well as ones on the end side 2b of the tool 2 may be imaged. The image areas 70.1, 70.2, 70.3 advantageously have a certain overlap so that they can subsequently be combined more easily with one another.

The data recorded by the white-light interferometer 20 are transmitted to a processing unit 30. This is a computer on which an image-processing module 31, a computation module 32 and a classifier module 33 are embodied in software. The image-processing module 31 receives the data of the white-light interferometer and initially joins a plurality of image areas 70.1, 70.2, 70.3 together so that images with a size of about 2×2 mm are ultimately produced. The resolution is about 1000×1000 pixels.

The images are on the one hand in the form of a three-dimensional representation, in which a depth value is assigned to each pixel of the measurement field. A corresponding representation is reproduced in FIG. 5, described below. Different grey values encode different depths.

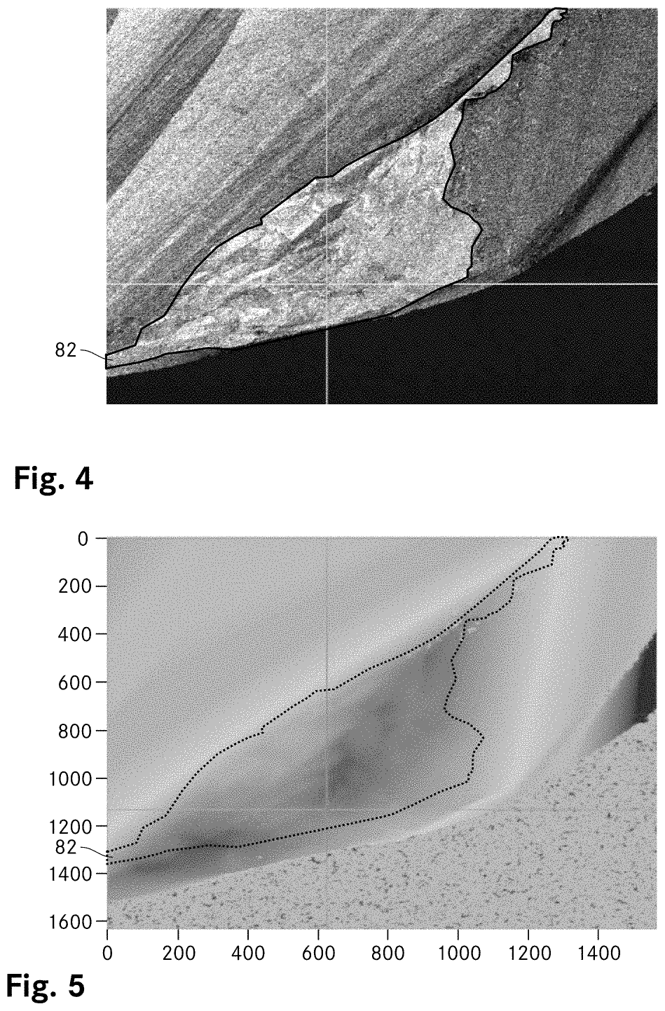

On the other hand, the image-processing module 31 generates a two-dimensional representation in which a brightness value is assigned to each pixel. This corresponds to the signal amplitude generated at the sensor (cf. FIGS. 3 and 4).

In the image-processing module 31, a wear zone is then identified on the basis of the two-dimensional representation, as described in more detail below. The information relating to the site of the wear zone and the three-dimensional geometry of the acquired section are then processed further by the computation module 32, as likewise presented below, so that a spatial extent of the wear zone is obtained. Lastly, the classifier module receives this result and allocates the tool to a wear class (“still usable”, “recondition”, “dispose of”).

In this way, each tool is checked for its state of wear after removal from the working spindle. It may be expedient to carry out a cleaning step before the checking, so that the measurements are not impaired by adhering dust or swarf. To this end, a cleaning apparatus, for example having a liquid or air nozzle, may be used. If the state of wear allows further use, the tool is placed in the tool magazine 13. If reconditioning is necessary, or the tool should be disposed of or recycled, it is moved into the removal position 14. At the same time, the result of the classification is displayed. Data relating to the tool 2 to be reconditioned are saved together with a unique identifier of the tool in a central database 3. The central identifier is also noted—for example optically or electronically—on the tool 2.

If the tool 2 needs to be reconditioned, it is sent in the conventional way to a reconditioning device 4. There, the identifier is initially read with a reader 53, for example by means of a camera or an RFID reader and downstream electronics. On the basis of the identifier, a controller 51 then retrieves the data relating to the tool 2 from the database 3. Subsequently, the reconditioning machine, for example a grinding machine 52, is controlled as a function of the retrieved data. The data comprise, for example, indications of the areas to be reconditioned (end, lateral surface; specific indication of the cutting or cutting regions) and/or information relating to the current geometry of the tool. The reconditioning may therefore be carried out efficiently and productively without further data acquisition. Information relating to the reconditioning carried out are in turn saved in the database 3 while being assigned to the tool identifier.

After reconditioning has been carried out, the tool 2 is sent back to the factory 1 (or to another factory). It may be used further there.

The detection of the wear zone in the image-processing module 31 is carried out on the basis of the two-dimensional representation (see FIGS. 3, 4) with the aid of an artificial neural network. Specifically, two networks are used for the detection of the wear zone, one for the lateral surface 2a of the tool and another for the end surface 2b of the tool. The different appearance of the wearing in the two areas may thus be taken into account. Both networks are of the VGG-16 type. The networks fully automatically detect which areas of the images represent wear zones and mark them correspondingly in a pixel map. In order to reduce the computation power required for the detection, and as a function of the original resolution of the image data, the resolution of the two-dimensional image data may initially be reduced with methods known per se in a preceding step. In the present case, the number of pixels to be processed may, for example, be reduced to one quarter if four pixels are in each case combined. This still gives a resolution of 500×500 pixels.

The training of the two networks was carried out on the basis of in total 1950 WLI amplitude images, which had initially been reduced to a resolution of 500×500 pixels. The images were segmented manually with an “image labeller” and then fed with the assignment of the wear zones into the neural network. After the training has been carried out, the networks are capable of fully automatically marking wear zones both on the lateral surface and on the end surface with a high accuracy. In FIGS. 3 and 4, the detected wear zones 81, 82 are bordered by a solid line. As is clear from comparison with FIG. 5, in which the wear zone 82 identified with the aid of FIG. 4 is indicated by a dotted line, the wear zone is significantly more easily identifiable in the two-dimensional representation of the signal amplitude than in the three-dimensional representation.

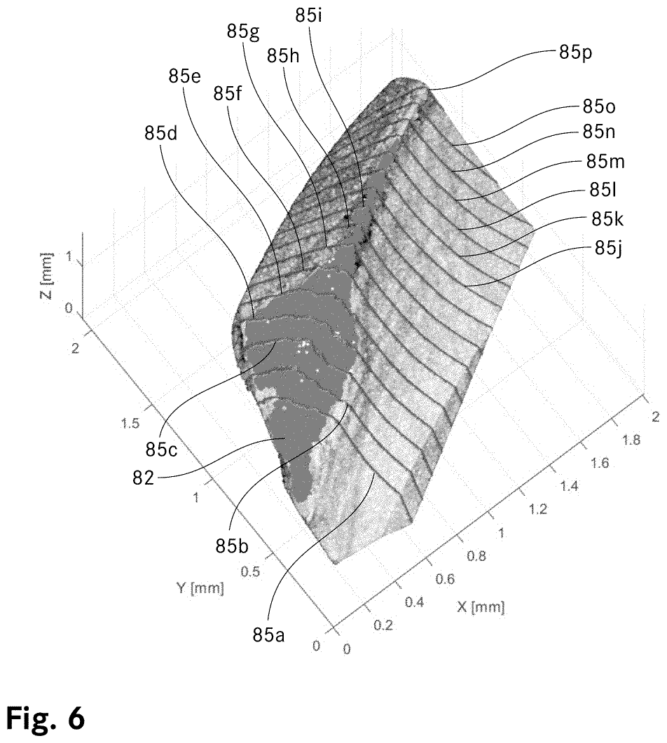

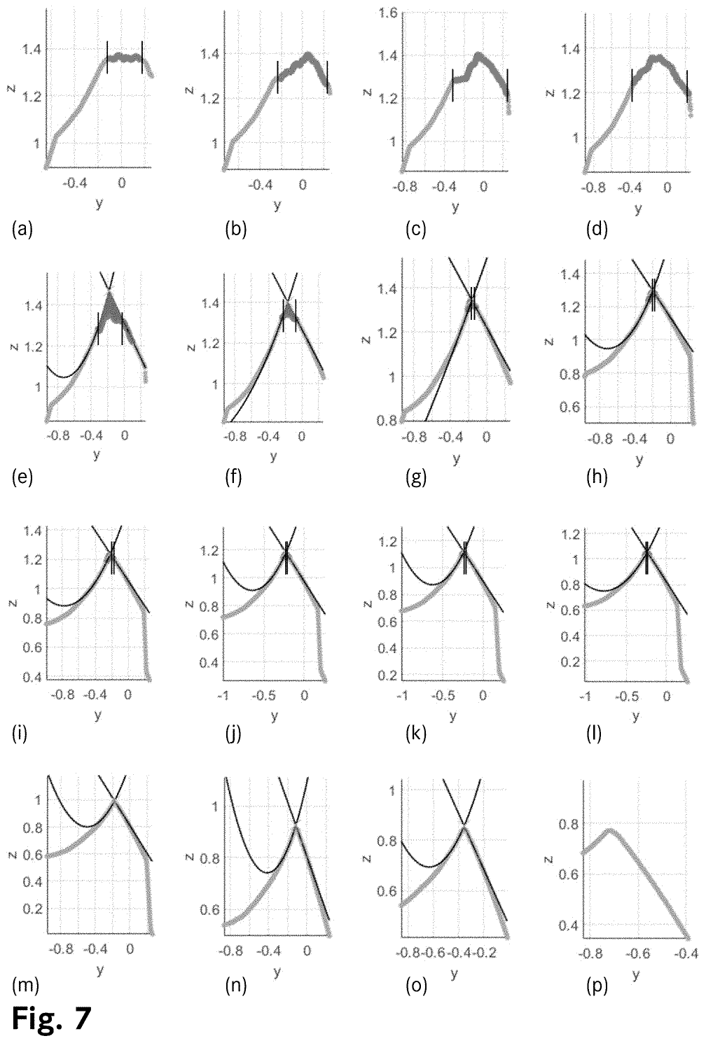

In the computation module 32, the measurement points affected by wear are transferred according to the pixel map into the 3D model and marked (cf. FIG. 6). As may be seen clearly in this reconstructed three-dimensional view of a cutting-tip and cutting-edge area of a milling tool, the situation at the cutting tip (left or bottom, in the area of the cross sections 85a . . . 85d) differs greatly from the situation at the actual cutting edge. In the area of the cutting tip, in contrast to the cutting-edge area, there are generally no (longer) free surfaces and/or cutting surfaces, on the basis of which a reconstruction of the cutting-edge geometry would be possible. The area of the cutting tip is therefore treated differently from the area of the cutting edge when determining the extent of the wear zone.

Specifically, in the region of the cutting tip, the number of pixels which have been marked as belonging to the wear zone in the pixel map is evaluated. This provides a first measure of the wear of the tool.

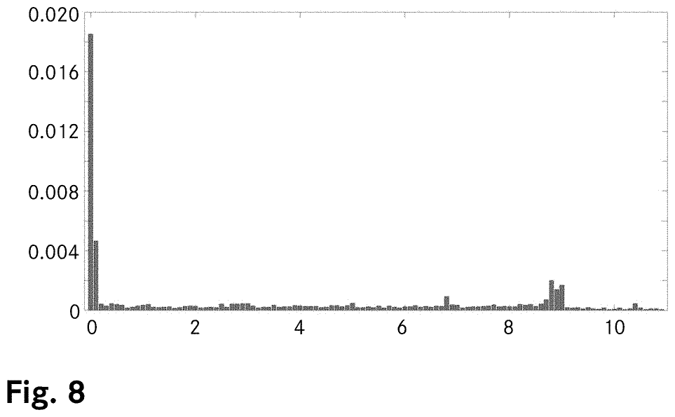

In the area of the cutting edge, in order to determine the spatial extent of the wear zone, the cutting edge is initially reconstructed in the area in question with the aid of the image data. “Slices” are cut from the 3D point cloud in order to reduce the computation outlay significantly; in the present case, 112 cross sections are generated, of which 16 cross sections 85a . . . 85p are represented in FIGS. 6 and 7. In those cross sections 85e . . . p which are attributed to the cutting edge, the original geometry is subsequently reconstructed (see FIG. 7). To this end, curve fitting with extrapolation (solid thin black lines) is respectively carried out for the free surface and the cutting surface, the areas of the surface which are affected by wear (respectively between the two vertical lines in cross sections (a)-(l)) being excluded from the fitting in order to prevent vitiation of the extrapolation. The point of intersection of the two curves for the free surface and the cutting surface is interpreted as a setpoint cutting edge. In the present case, a fit with second-order polynomials already provides good results. Subsequently, the surface area difference between the reconstructed geometry and the actual geometry is calculated as a wear surface in the respective cross section (marked surface, visible particularly clearly in FIGS. 7(e), 7(f)).

FIG. 8 shows a bar chart with the wear surfaces along a cutting edge, here for all 112 cross sections considered. The vertical axis in this case denotes the wear surface in mm², and the horizontal axis represents the position along the cutting edge.

A suitable sum of the wear surfaces finally corresponds to the wear volume.

In order to obtain a measure of the wear, an average value of all cross-sectional wear surfaces may also simply be formed. Together with the total number of “wear pixels” of all cutting tips, two measures which quantify the wear are therefore available.

In the classifier module 33, the state of wear of the tool is finally classified with the aid of the two measures. The classification may, for example, in a simple case be carried out according to the following scheme:

| | Average | Total number | |
|---|---|---|---|
| | value of | of wear | |
| | cross-sectional | pixels of the | |
| Scenario | wear surfaces | cutting tips | Classification |
| A | ≤T_{QV1} | ≤T_{NVP1} | still usable |
| B | >T_{QV1}, ≤T_{QV2} | irrelevant | still usable, watch |
| C | irrelevant | >T_{NVP1}, ≤T_{NVP2} | still usable, watch |
| D | >T_{QV2}, ≤T_{QV3} | ≤T_{NVP3} | recondition |
| E | ≤T_{QV3} | >T_{NVP2}, ≤T_{NVP3} | recondition |
| F | >T_{QV3} | irrelevant | recycle |
| G | irrelevant | >T_{NVP3} | recycle |

Here, the parameters Tₓ denote limit values which may be specified tool-specifically. The classification “watch” means that the tool needs to be checked again after a certain time of use or a number of use cycles, because the wear limit could soon occur. The time of use or cycle number is in this case specified to be less than for all tools in general.

In more complex scenarios, the tools may still be used in certain cases in a restricted range of application, so that further classes may be formed.

The measures may also be based on a more complex definition. Thus, different areas of the cutting edge or of the cutting tip may, for example, be weighted differently in order to take into account the different importance when using the tool. Furthermore, the wear surfaces (or other local measures of the wear) may also be taken into account individually. For example, a tool for which at least one local measure exceeds a predetermined (relatively high) limit value may therefore automatically be allocated to the category “recondition” or to the category “recycle”, regardless of what the global measures are.

If required, three or more measures may also be generated and evaluated for the classification.

The invention is not restricted to the exemplary embodiment represented. For instance, individual components may also be configured differently or arranged differently. The detection and analysis of the image data may be carried out in another way, and details of the method may be adapted to the specific tool type.

In summary, it is to be stated that the invention provides a method for determining the state of wear of a tool, which can automatically and reliably detect the state of wear of a tool.

1. A method for determining the state of wear of a tool, comprising the following steps:
a) recording at least one optical image of a surface of the tool;
b) processing image data of the at least one optical image in order to detect a wear zone;
c) determining a surface extent and/or spatial extent of the wear zone;
d) classifying the state of wear of the tool on the basis of the extent determined.

2. A method according to claim 1, wherein the image data comprise a two-dimensional image of the surface, and in that the image data corresponding to the two-dimensional image are used to detect the wear zone.

3. A method according to claim 1, wherein the image data comprise a three-dimensional image of the surface, and in that the image data corresponding to the three-dimensional image are used to detect the wear zone and/or to determine the extent of the wear zone.

4. A method according to claim 1, wherein the method is configured to determine the state of wear of one of the following tools:
an electrode for eroding in a sinker EDM machine,
a wire for eroding in a wire EDM machine,
a grinding or drilling tool for workpiece processing in a machine tool.

5. A method according to claim 1, wherein a spatial deviation of a current profile of the surface from a setpoint profile of a cutting edge is determined in order to determine the extent of the wear zone.

6. A method according to claim 5, wherein the setpoint profile of the cutting edge of the tool is reconstructed on the basis of the image data.

7. A method according to claim 5, wherein a wear volume is calculated with the aid of the deviation determined.

8. A method according to claim 1, wherein the state of wear of a solid-shaft tool is determined, a first state of wear of a cutting geometry on the lateral side and a second state of wear of a cutting geometry on the end side being determined separately.

9. A method according to claim 8, wherein an algorithm based on a first data set is used to determine the first state of wear, and in that an algorithm based on a second data set is used to determine the second state of wear, the first data set and the second data set being different.

10. A method for reconditioning a tool, comprising the following steps:
a) determining the state of wear of a tool with a method according to claim 1;
b) controlling at least one device for reconditioning the tool, in particular by means of a grinding process, when the state of wear satisfies predetermined conditions.

11. A method according to claim 10, wherein a processing geometry of the device for reconditioning the tool is determined with the aid of the at least one recorded optical image.

12. A method according to claim 10, wherein a device for recording the at least one optical image is arranged at a first use location, in that data obtained at the first use location are saved in a database, in that the reconditioning device is arranged at a second use location, and in that the reconditioning device retrieves data from the database.

13. A method according to claim 12, wherein the tool is provided with a unique identifier, and in that the data assigned to the tool in the database are linked with the unique identifier.

14. An apparatus for determining the state of wear of a tool, comprising:
a) a camera for recording at least one optical image of a surface of the tool;
b) an image processing module, which is configured in such a way that it processes image data of the at least one optical image in order to detect a wear zone;
c) a computation module, which is configured in such a way that it determines a surface extent and/or spatial extent of the wear zone; and
d) a classifier module, which is configured in such a way that it classifies the state of wear of the tool on the basis of the extent determined.

15. An apparatus according to claim 14, wherein the camera is integrated into a processing machine having a holder for the tool, particularly in such a way that the camera can record the optical image of the surface of the tool when the tool is held in the holder.

16. A machine tool arrangement, comprising a machine tool, preferably a processing centre, a sinker or wire EDM machine or a drilling centre, and an apparatus according to claim 14, wherein the camera is integrated into the machine tool or is arranged thereon, and in that the image processing module, the computation module and the classifier module are held in a processing apparatus, the processing apparatus being fully or partially contained in the machine tool or being arranged externally to the latter and connected to it in respect of signals.

17. An arrangement, comprising:
a) an apparatus for determining the state of wear of a tool according to claim 14;
b) a device for reconditioning the tool, in particular by means of a grinding process;
c) a controller for controlling the reconditioning device, which is configured in such a way that it receives information relating to the state of wear from the determination device and controls the device for reconditioning the tool as a function of the information received.
